(19) United States
(12) Patent Application Publication
(10) Pub. No.: US 2013/0177164 A1
(43) Pub. Date: Jul. 11, 2013

(54) ULTRASONIC SOUND REPRODUCTION ON EARDRUM

(71) Applicant: Dag Glebe, Sodra Sandby (SE)

(72) Inventor: Dag Glebe, Sodra Sandby (SE)

(73) Assignee: SONY ERICSSON MOBILE COMMUNICATIONS AB, Lund (SE)

(21) Appl. No.: 13/345,514

(22) Filed: Jan. 6, 2012

(51) Int. Cl. H04R 1/10

(52) U.S. Cl. 381/74

(57) ABSTRACT

The invention is directed to systems, methods and computer program products for producing audible sound by directing ultrasonic signals from an ultrasonic transducer towards an eardrum. An exemplary method includes providing an earphone comprising an ultrasonic transducer, wherein the earphone is positioned close to an ear, wherein the ear includes an ear canal and an eardrum; producing, by the ultrasonic transducer, an ultrasonic signal; and transmitting, by the ultrasonic transducer, the ultrasonic signal, wherein the ultrasonic signal is directed into the ear canal towards the eardrum such that the eardrum receives the ultrasonic sound signal and initiates conversion of the ultrasonic signal into audible sound.

### BACKGROUND

Several approaches have been used in the construction of earphones. One particular approach is a blocked construction. In a blocked construction, an earphone may block one or more parts of the ear. There are several disadvantages with a blocked construction. One disadvantage is that a user who is wearing an earphone that blocks one or more parts of the ear and is simultaneously talking out loud may experience a perceived difference in how his or her voice sounds. The user may be startled or disturbed by this experience. Additionally, when a user is wearing an earphone that blocks one or more parts of the ear, the user may not be able to hear sounds (or the sounds may be muffled) from the external environment. Sometimes, these sounds from the external environment are useful. For example, a useful sound may be a notification from the external environment that demands the user's attention, e.g., someone calling the user's name, ringing of a doorbell, etc.

Another particular approach is an open construction. In an open construction, an earphone may only partially block one or more parts of the ear. There are several disadvantages with an open construction. There may be substantial leakage of sound out from the earphone to the environment. This may be substantial for low frequency sound, and in some instances, high frequency sound as well. The leaked sound may be heard by other people in the environment surrounding the user (e.g., in a crowded bus or train) and may be perceived as an annoyance by those other people. Additionally, when the noise level in the environment surrounding the user is high, the environmental sound may mask the sound emitted from the earphone.

Therefore, what is needed is an earphone that addresses the above-described disadvantages associated with earphone technology.

### BRIEF SUMMARY

Embodiments of the invention are directed to systems, methods and computer program products for producing audible sound by directing ultrasonic signals from an ultrasonic transducer towards an eardrum. An exemplary method includes providing an earphone comprising an ultrasonic transducer, wherein the earphone is positioned close to an ear, wherein the ear includes an ear canal and an eardrum; producing, by the ultrasonic transducer, an ultrasonic signal; and transmitting, by the ultrasonic transducer, the ultrasonic signal, wherein the ultrasonic signal is directed into the ear canal towards the eardrum such that the eardrum receives the ultrasonic sound signal and initiates conversion of the ultrasonic signal into audible sound.

Additionally, in some embodiments, the method includes determining, by the earphone or the ultrasonic transducer or some other component associated with the earphone, a sound pressure to be produced on the eardrum; determining, by the earphone or the ultrasonic transducer or some other component associated with the earphone, a signal energy associated with the ultrasonic signal based at least partially on the determined sound pressure. Additionally, in some embodiments, the producing step further comprises producing an ultrasonic signal based at least partially on the determined signal energy.

Additionally, in some embodiments, the producing step comprises: receiving, by the ultrasonic transducer or some other component associated with the earphone, a wired or wireless signal; and converting, by the ultrasonic traducer or some other component associated with the earphone, the received signal into an ultrasonic signal.

Additionally, in some embodiments, the transmitted ultrasonic signal is a low-power ultrasonic signal thereby reducing leakage of the ultrasonic signal to the environment surrounding the ear.

Additionally, in some embodiments, the method further comprises modulating, by the ultrasonic transducer or some other component associated with the earphone, the ultrasonic signal prior to transmitting the ultrasonic signal.

Additionally, in some embodiments, the modulated ultrasonic signal carries an audible signal.

Additionally, in some embodiments, the modulating step comprises modulating at least one of the frequency, amplitude, or phase of the ultrasonic signal.

Additionally, in some embodiments, the method comprises compensating, by the ultrasonic transducer or some other component associated with the earphone, the modulated ultrasonic signal to compensate for one or more objects or surfaces encountered during transmission of the modulated ultrasonic signal.

Additionally, in some embodiments, the ultrasonic signal is produced in the ear canal. In other embodiments, the ultrasonic signal is produced outside the ear.

Additionally, in some embodiments, the ear canal is at least partially blocked by the earphone. In other embodiments, the ear canal is not blocked by the earphone.

Additionally, in some embodiments, the method further comprises determining, by the earphone or the ultrasonic transducer or some other component associated with the earphone, a distance between the ultrasonic transducer and the eardrum; comparing, by the ultrasonic transducer or some other component associated with the earphone, the determined distance with one or more predetermined threshold distances; in response to determining the determined distance is less than a first threshold distance, transmitting the ultrasonic signal without compensating the ultrasonic signal; and in response to determining the determined distance is greater than the first threshold distance, compensating the ultrasonic signal prior to transmitting the ultrasonic signal, wherein the amount of compensation associated with the ultrasonic signal increases as the determined distance increases.

In some embodiments, an exemplary system comprises an earphone comprising an ultrasonic transducer, wherein the earphone is positioned close to an ear, wherein the ear includes an ear canal and an eardrum, and wherein the ultrasonic transducer is configured to produce an ultrasonic signal and transmit the ultrasonic signal into the ear canal towards the eardrum such that the eardrum receives the ultrasonic signal and initiates conversion of the ultrasonic signal into audible sound.

In some embodiments, the earphone is further configured to: determine a sound pressure to be produced on the eardrum; and determine a signal energy associated with the ultrasonic signal based at least partially on the determined sound pressure, wherein the produced ultrasonic signal is based at least partially on the determined signal energy.

In some embodiments, the earphone is further configured to: receive a wired or wireless signal; and convert, using the earphone or the ultrasonic traducer, the received signal into an ultrasonic signal. In some embodiments, the transmitted ultrasonic signal is a low-power ultrasonic signal thereby reducing leakage of the ultrasonic signal to the environment surrounding the ear.

In some embodiments, an exemplary computer program product for producing audible sound comprises a non-transitory computer-readable medium comprising code configured to cause an earphone to produce an ultrasonic signal and transmit the ultrasonic signal into an ear canal towards an eardrum such that the eardrum receives the ultrasonic signal and initiates conversion of the ultrasonic signal into audible sound, wherein the earphone comprises an ultrasonic transducer, wherein the earphone is positioned close to an ear that includes the ear canal and the eardrum.

In some embodiments, the code is further configured to cause the earphone to: determine a sound pressure to be produced on the eardrum; and determine a signal energy associated with the ultrasonic signal based at least partially on the determined sound pressure, wherein the produced ultrasonic signal is based at least partially on the determined signal energy. In some embodiments, the code is further configured to cause the earphone to: receive a wired or wireless signal; and convert the received signal into an ultrasonic signal.

### BRIEF DESCRIPTION OF THE DRAWINGS

Having thus described embodiments of the invention in general terms, reference will now be made to the accompanying drawings, where:

FIG. 1 is an exemplary system environment for producing audible sound by directing ultrasonic signals from an ultrasonic transducer towards an eardrum, in accordance with embodiments of the present invention; and

FIG. 2 is an exemplary process flow for producing audible sound by directing ultrasonic signals from an ultrasonic transducer towards an eardrum, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products for producing audible sound by directing ultrasonic signals from an ultrasonic transducer towards an eardrum. The eardrum is a thin membrane that separates the external ear from the middle ear. The function of the eardrum is to transmit sound from the air to the middle ear. The external or outer ear includes the pinna, concha, and external auditory meatus, and the function of the external ear is to gather sound energy and focus the sound energy onto the eardrum. As used herein, ultrasound or ultrasonic sound refers to sound pressure associated with frequencies greater than the upper limit of human hearing. For a healthy adult human being, this upper limit is about 20 kHz. The upper limit is approximately 20 kHz because the middle ear acts a low-pass filter.

As used herein, a transducer is a device that converts one form of energy to another form. An ultrasonic transducer may convert wired or wireless electrical signals into ultrasonic signals. An example of a wired electrical signal is an electrical signal received from an audio source such as an audio player, a computing device, a communication device, etc. An example of a wireless electrical signal is a wireless signal received from a wireless source such as a radio base station, an audio player, a computing device, a communication device, etc. The transducer may be located in an earphone. The earphone may be part of a device that includes a single earphone, a pair of (i.e., two) earphones, more than two earphones, etc. When there is more than one earphone, each earphone may include one or more ultrasonic transducers. In some embodiments, the device may be a headset (e.g., a hands-free headset).

As used herein, ultrasound may also be referred to as ultrasonic sound, ultrasonic signals, ultrasonic sound signals, ultrasonic sound waves, ultrasound signals, ultrasound waves, etc.

Ultrasound is highly directional and can be used for targeting objects situated far away. In some embodiments, an ultrasonic signal may be modulated similar to a radio carrier signal. For example, one type of modulation scheme that may be applied to the ultrasonic signal is single sideband modulated amplitude modulation (AM). The invention is not limited to the modulation scheme described herein. In alternate embodiments, other modulation schemes may be used, e.g., frequency modulation, phase modulation, double sideband modulation, multiple sideband modulation, etc. The modulated ultrasonic signal carries a signal that becomes audible when the modulated ultrasonic signal hits an object (e.g., the eardrum) or a boundary or a surface that acts as demodulator. Sometimes, the object may even be a non-linearity (e.g., a particle) in the air. Sometimes, the surface may be the surface near or at the outer ear. These objects/boundaries/surfaces may cause distortion of the modulated signal.

In some embodiments, an ultrasonic signal (e.g., a modulated ultrasonic signal) may be transmitted over a large distance. In such embodiments, since audible sound is produced when the modulated ultrasonic signal encounters or hits an object or surface prior to hitting the eardrum, the sound field is a frequency dependent mix of near-field and far-field signals. Therefore, in order to counter the distortion of the modulated signal caused by demodulation at objects or boundaries or surfaces that are encountered prior to the eardrum as described above, the modulated ultrasonic signal is compensated prior to transmission. The total distortion caused by demodulation at objects or boundaries or surfaces encountered prior to the eardrum is greater when the ultrasonic signal is a high-power ultrasonic signal and when the ultrasonic signal is transmitted over large distances. Therefore, the amount of compensation increases as the distance of transmission increases and as the power level associated with the modulated ultrasonic signal increases.

Additionally, over longer distances, the power dissipation or power lost by the ultrasonic signal is also greater because the ultrasonic signal encounters more objects/boundaries/surfaces. Therefore, the modulated ultrasonic signal may need to be compensated because of the predicted power loss associated with the ultrasonic signal during transmission of the ultrasonic signal.

In some embodiments, the amount of power lost by the ultrasonic signal during transmission is reduced because the ultrasonic signal is transmitted over a very short distance from the ultrasonic transducer to the eardrum. Therefore, since the power loss is reduced, the ultrasonic signal can be produced at low power levels. Since the ultrasonic signal is produced at low power levels, the demodulation of the signal caused by objects (e.g., non-linearities in the air) described previously is also reduced.

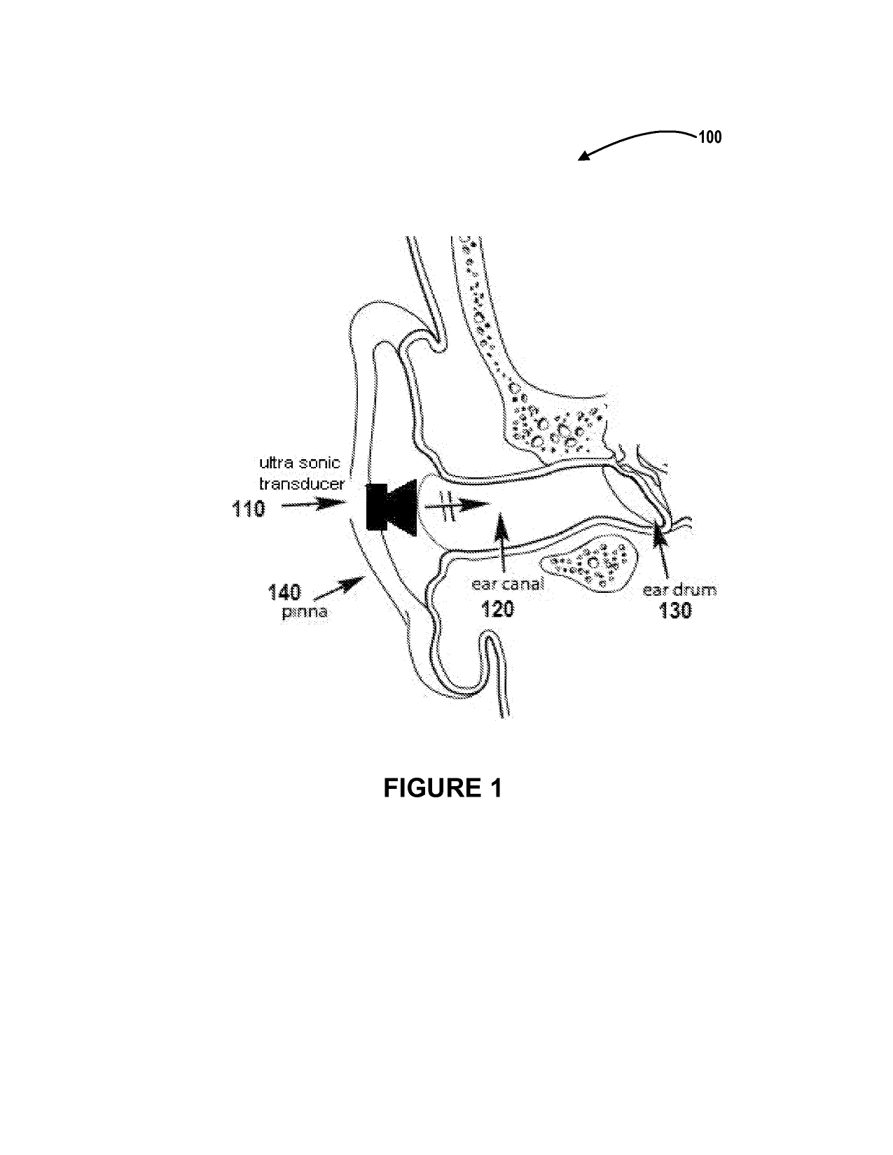

Referring now to FIG. 1, FIG. 1 presents a system environment 100 for producing audible sound by directing ultrasonic signals from an ultrasonic transducer 110 towards an eardrum 130. FIG. 1 shows an ear with a pinna 140, an ear canal 120, and an eardrum 130. The pinna 140 is the outer part of the ear. In embodiments of the invention, an ultrasonic signal produced by the ultrasonic transducer 110 is directed into the ear canal 120 towards the eardrum 130. In some embodiments, the ultrasonic transducer 110 determines the amount of pressure (e.g., minimum amount of pressure and/or maximum amount of pressure) needed at the eardrum 130 in order for the eardrum 130 to initiate conversion of the ultrasonic signal into an audible signal. In some embodiments, the amount of pressure is actively determined by the ultrasonic transducer 110 (or some other component of the earphone) and varies from eardrum to eardrum or from person to person. In some embodiments, the amount of pressure is a predetermined value that is stored in the ultrasonic transducer 110 or in the earphone or may be accessed by the earphone from a remote resource. In some embodiments, the amount of pressure may be determined by software associated with the ultrasonic transducer 110. Subsequently, the ultrasonic transducer 110 (or some other component in the earphone) determines the amount of ultrasonic signal energy to be directed towards the eardrum 130 based at least partially on the previously determined pressure needed at the eardrum 130.

In some embodiments, the ultrasonic signal can be produced outside the ear and can be directed into the ear canal 120. In such embodiments, the ultrasonic transducer 110 may be positioned further away from the ear canal 120 (e.g., the ultrasonic transducer 110 may not be positioned at the edge of the ear canal 120 as presented in FIG. 1). In other embodiments, the ultrasonic signal can be produced in the ear canal 120. In such embodiments, the ultrasonic transducer 110 may be positioned closer to the ear canal 120 (e.g., the ultrasonic transducer 110 may be positioned at the edge of the ear canal 120 as presented in FIG. 1). In other embodiments, the ultrasonic transducer 110 may be positioned on the outer ear. In still other embodiments, the ultrasonic transducer 110 may be positioned further away from the ear (e.g., a few meters away). In some embodiments, regardless of the distance from the ultrasonic transducer 110 to the eardrum 130, the ultrasonic signal produced by the ultrasonic transducer 110 is a modulated ultrasonic signal. As the distance from the ultrasonic transducer 110 to the eardrum 130 increases, an amount of compensation associated with the modulated ultrasonic signal may need to increase in order to produce an audible signal at the eardrum 130.

In some embodiments, the ear canal 120 (and/or the outer ear and/or the concha) is at least partially or completely blocked by the earphone which includes the ultrasonic transducer 110. In other embodiments, the ear canal 120 (and/or the outer ear and/or the concha) is not blocked by the earphone which includes the ultrasonic transducer 110. Therefore, the performance of embodiments of the invention is substantially transparent to the ambient sound field (environmental sounds).

Embodiments of the invention reduce the leakage or the amount of sound energy lost due to dissipation or attenuation of the ultrasonic signals. This is because the ultrasonic signals produced by the ultrasonic transducer 110 are low-power signals. Additionally, the leakage is reduced because of the low power dissipation for the ultrasonic signals over short-ranges and because of the high directivity or directionality for the ultrasonic signals. The transmission dissipation is low because there are fewer objects or surfaces encountered over the short-range distance between the ultrasonic transducer 110 and the eardrum 130.

In some embodiments, the earphone or the ultrasonic transducer 110 in the earphone may determine the distance from the ultrasonic transducer 110 or the earphone to the eardrum 130. This may be accomplished using a proximity sensor that is comprised within the ultrasonic transducer 110 or within the earphone that comprises the ultrasonic transducer 110. In other embodiments, a user may enter key input or voice input of an approximate distance via a user interface of a computing device that is in communication with the earphone. The earphone, or a processor associated with the earphone, may then compare the distance with a table of predetermined threshold distances. In response to determining the distance between the ultrasonic transducer 110 and the eardrum 130 is less than a particular threshold, the ultrasonic transducer 110 does not compensate the transmitted ultrasonic signal, where the transmitted ultrasonic signal has already been modulated by the ultrasonic transducer 110. In response to determining the distance between the ultrasonic transducer 110 and the eardrum 130 is greater than the particular threshold, the ultrasonic transducer 110 compensates the transmitted ultrasonic signal, where the transmitted ultrasonic signal has already been modulated by the ultrasonic transducer 110. In some embodiments, the amount of compensation of the transmitted ultrasonic signal increases as the determined distance between the ultrasonic transducer 110 and the eardrum 130 increases.

Audible sound waves that are produced by an earphone are acousto-mechanically (or just acoustically) filtered due to earphone design and the fit of the earphone. This filtering can often lead to an alteration of the desired audible sound waves produced by the earphone. Embodiments of the invention overcome this disadvantage by using ultrasonic signals which are not acousto-mechanically filtered due to earphone design and the physical fit of the earphone with a user of the earphone. Therefore, embodiments of the invention are minimally affected by earphone design and the fit of the earphone.

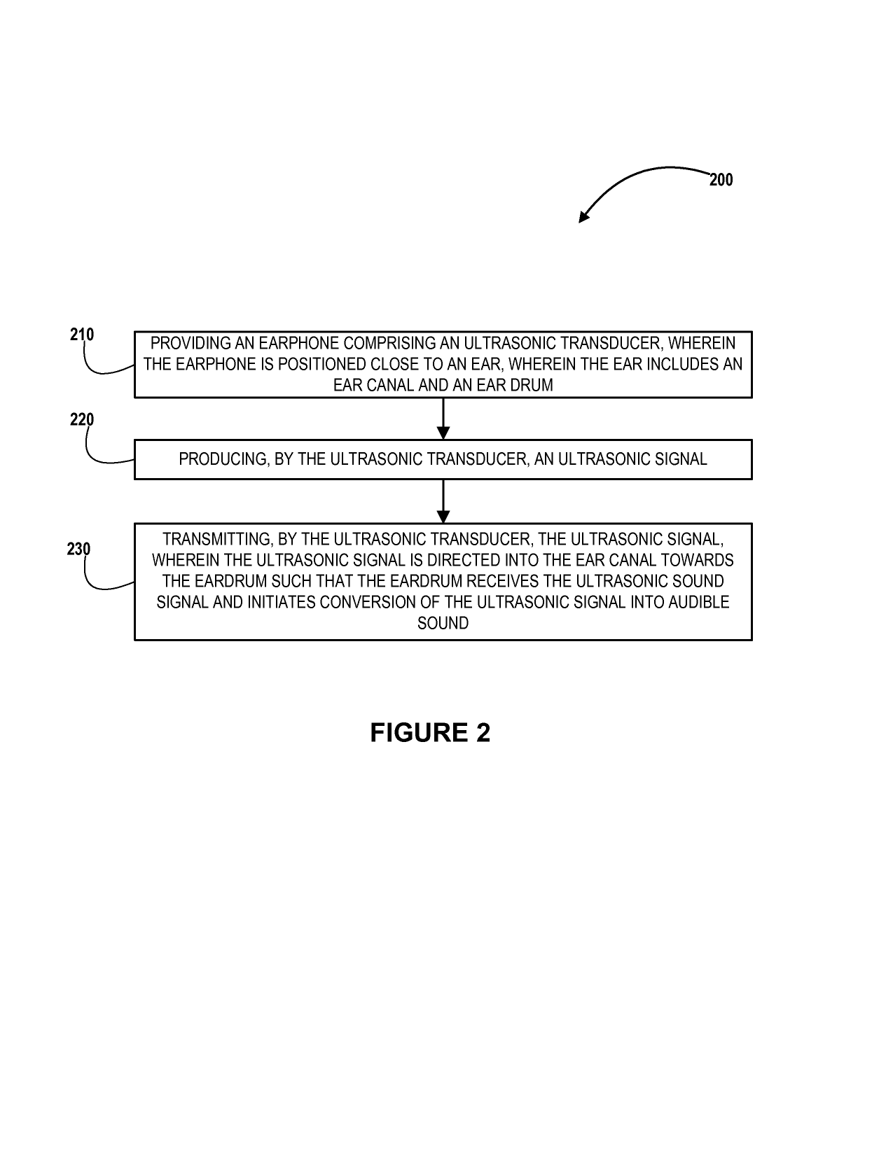

Referring now to FIG. 2, FIG. 2 presents a process flow 200 for producing audible sound by directing ultrasonic signals from an ultrasonic transducer towards an eardrum. At block 210, the process flow includes the step of providing an earphone comprising an ultrasonic transducer, wherein the earphone is positioned close to an ear, wherein the ear includes an ear canal and an eardrum. At block 220, the process flow includes the step of producing, by the ultrasonic transducer, an ultrasonic signal. As explained previously, the producing may be based partially on the steps of determining a sound pressure to be produced on the eardrum, and determining a signal energy associated with the ultrasonic signal based at least partially on the determined sound pressure. Both the determining steps may be executed by the ultrasonic transducer or by some other component in the earphone. Therefore, the ultrasonic signal may be produced by the ultrasonic transducer based at least partially on the determined signal energy. At block 230, the process flow includes the step of transmitting, by the ultrasonic transducer, the ultrasonic signal, wherein the ultrasonic signal is directed into the ear canal towards the eardrum such that the eardrum receives the ultrasonic sound signal and initiates conversion of the ultrasonic signal into audible sound by transmitting the ultrasonic sound signal to the middle ear.

In accordance with embodiments of the invention, the term “module” with respect to a system (or a device) may refer to a hardware component of the system, a software component of the system, or a component of the system that includes both hardware and software. As used herein, a module may include one or more modules, where each module may reside in separate pieces of hardware or software.

As used herein, the term “automatic” refers to a function, a process, a method, or any part thereof, which is executed by computer software upon occurrence of an event or a condition without intervention by a user.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A method for producing an audible sound to be received by an ear having an ear canal and an ear drum, the method comprising:
providing an earphone comprising an ultrasonic transducer, wherein the earphone is positioned close to the ear;
producing, by the ultrasonic transducer, an ultrasonic signal; and
transmitting, by the ultrasonic transducer, the ultrasonic signal, wherein the ultrasonic signal is directed into the ear canal towards the eardrum such that the eardrum receives the ultrasonic signal and initiates conversion of the ultrasonic signal into audible sound.

2. The method of claim 1, further comprising:
determining a sound pressure to be produced on the eardrum;
determining a signal energy associated with the ultrasonic signal based at least partially on the determined sound pressure; and
wherein the producing step further comprises producing an ultrasonic signal based at least partially on the determined signal energy.

3. The method of claim 1, wherein the producing step comprises:
receiving, by the ultrasonic transducer, a wired or wireless signal; and
converting, by the ultrasonic traducer, the received signal into an ultrasonic signal.

4. The method of claim 1, wherein the transmitted ultrasonic signal is a low-power ultrasonic signal thereby reducing leakage of the ultrasonic signal to the environment surrounding the ear.

5. The method of claim 1, further comprising modulating the ultrasonic signal prior to transmitting the ultrasonic signal.

6. The method of claim 5, wherein the modulated ultrasonic signal carries an audible signal.

7. The method of claim 5, wherein the modulating step comprises modulating at least one of the frequency, amplitude, or phase of the ultrasonic signal.

8. The method of claim 5, further comprising compensating the modulated ultrasonic signal to compensate for at least one object or surface encountered during transmission of the modulated ultrasonic signal.

9. The method of claim 1, wherein the ultrasonic signal is produced in the ear canal.

10. The method of claim 1, wherein the ultrasonic signal is produced outside the ear.

11. The method of claim 1, wherein the ear canal is at least partially blocked by the earphone.

12. The method of claim 1, wherein the ear canal is not blocked by the earphone.

13. The method of claim 1, further comprising:
determining, by the earphone, a distance between the ultrasonic transducer and the eardrum;
comparing the determined distance with at least one predetermined threshold distance;
in response to determining the determined distance is less than a first threshold distance, transmitting the ultrasonic signal without compensating the ultrasonic signal; and
in response to determining the determined distance is greater than the first threshold distance, compensating the ultrasonic signal prior to transmitting the ultrasonic signal, wherein an amount of compensation associated with the ultrasonic signal increases as the determined distance increases.

14. A system for producing audible sound, the system comprising:
an earphone comprising an ultrasonic transducer, wherein the earphone is positioned close to an ear;
wherein the ear includes an ear canal and an eardrum; and
wherein the ultrasonic transducer is configured to produce an ultrasonic signal and transmit the ultrasonic signal into the ear canal towards the eardrum such that the eardrum receives the ultrasonic signal and initiates conversion of the ultrasonic signal into audible sound.

15. The system of claim 14, wherein the earphone is further configured to:
determine a sound pressure to be produced on the eardrum;
determine a signal energy associated with the ultrasonic signal based at least partially on the determined sound pressure; and
wherein the produced ultrasonic signal is based at least partially on the determined signal energy.

16. The system of claim 14, wherein the earphone is further configured to:
receive a wired or wireless signal; and
convert, using the ultrasonic traducer, the received signal into an ultrasonic signal.

17. The system of claim 14, wherein the transmitted ultrasonic signal is a low-power ultrasonic signal thereby reducing leakage of the ultrasonic signal to the environment surrounding the ear.

18. A computer program product for producing audible sound, the computer program product comprising:
a non-transitory computer-readable medium comprising code configured to cause an earphone to produce an ultrasonic signal and transmit the ultrasonic signal into an ear canal towards an eardrum such that the eardrum receives the ultrasonic signal and initiates conversion of the ultrasonic signal into audible sound; and
wherein the earphone comprises an ultrasonic transducer, wherein the earphone is positioned close to an ear that includes the ear canal and the eardrum.

19. The computer program product of claim 18, wherein the code is further configured to cause the earphone to:
determine a sound pressure to be produced on the eardrum;
determine a signal energy associated with the ultrasonic signal based at least partially on the determined sound pressure; and
wherein the produced ultrasonic signal is based at least partially on the determined signal energy.

20. The computer program product of claim 18, wherein the code is further configured to cause the earphone to:
receive a wired or wireless signal; and
convert the received signal into an ultrasonic signal.
